(19) United States
(12) Patent Application Publication
(10) Pub. No.: US 2024/0222985 A1
(43) Pub. Date: Jul. 4, 2024

(54) SYSTEMS AND METHODS FOR MANAGING BATTERY ARRAYS

(71) Applicant: Shanghai Makesens Energy Storage Technology Co., Ltd., Shanghai (CN)

(72) Inventors: Enhai Zhao, Shanghai (CN); Xiao Yan, Shanghai (CN)

(21) Appl. No.: 18/607,704

(22) Filed: Mar. 18, 2024

Related U.S. Application Data
(63) Continuation of application No. PCT/CN2022/107000, filed on Jul. 21, 2022.

(30) Foreign Application Priority Data
Sep. 18, 2021 (CN) 202111099041.7

(51) Int. Cl. H02J 7/00

(52) U.S. Cl. CPC H02J 7/0019; H02J 7/0016; H02J 7/0048; H02J 7/005; H02J 7/007182; H02J 2207/20

(57) ABSTRACT

The invention relates to system and method for managing a battery array. The system comprises: a bus; a connecting unit coupled between the battery array and the bus; an active balancing unit for performing constant current charging of each battery unit connected to the bus through a DC-DC converter to achieve active balancing of said battery unit; a passive balancing unit for performing constant current discharging of each battery unit connected to the bus to perform passive balancing of said battery unit; a sensing unit for sensing battery parameters of each battery unit connected to the bus; and a control unit for controlling the connection unit to connect the plurality of battery units to the bus in turn, and the active balancing unit and the passive balancing unit, based on the sensed battery parameters of said battery unit connected to the bus, to perform balancing operations of said battery unit.

### CROSS-REFERENCE TO RELATED PATENT APPLICATIONS

This application is a continuation application of International Patent Application No. PCT/CN2022/107000, filed Jul. 21, 2022, which itself claims priority to Chinese Patent Application No. 202111099041.7, filed Sep. 18, 2021, which are hereby incorporated herein in their entireties by reference.

### FIELD OF THE INVENTION

The invention relates generally to battery management, and more particularly, to a battery management system configured to facilitate high integration through integrated circuit technology and a management method using the management system.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

Currently, rechargeable batteries having high energy density, such as lead-acid batteries and lithium-ion batteries, have recently been widely used. Multiple high-capacity rechargeable batteries (also referred to herein as battery units or cells) may be connected in series into a battery group, and multiple such battery groups may be connected in parallel to form a high-capacity battery array. Such high-capacity battery arrays are becoming increasingly important in a range of applications. Such applications may include, for example, power sources for automobiles, ships, and other vehicles, domestic and uninterruptible power supplies, and storage of electrical energy generated from intermittent and renewable sources for power needs and loads in domestic and grid-connected power networks balance and so on.

Typically, each battery unit can be maintained in a proper operating state by controlling the charging and discharging of individual battery units (also known as cells). The management system of the battery array used for this purpose, also known as the battery management system (BMS), can be configured to sense the battery parameters of each battery unit, so that the deviation between the battery parameters of individual battery units or battery groups is maintained at expected range, so as to ensure that each battery unit maintains the same working state during normal use, so as to ensure the safety and stability of the battery array and prolong the service life of the battery array. This management of the BMS is called consistency management of the battery array.

The management system of the battery array is usually composed of power semiconductor devices, analog circuits and digital circuits, so it is difficult to integrate in a single integrated circuit chip.

Therefore, a heretofore unaddressed need exists in the art to address the aforementioned deficiencies and inadequacies.

### SUMMARY OF THE INVENTION

In view of the aforementioned deficiencies and inadequacies in the prior art, one of the objectives of this invention is to provide a system and a method for managing a battery array (or alternatively, a battery array management system and a battery array management method). In some examples, the battery array includes a plurality of battery groups connected in parallel, each battery group includes a plurality of battery units connected in series. It should be noted that the battery groups and battery units in the battery array can be connected to each other in other configurations.

According to the invention, the battery array management system can realize the functions of parameter sensing, active balancing and passive balancing of each battery unit in a time-division multiplexing manner by using a switch array, thereby simplifying the hardware structure of the battery array management system. In addition, the hardware structure of the battery array management system can be further simplified by optimizing the DC-DC converter used for charging the battery units. By simplifying the hardware structure of the battery array management system, the integration degree of the battery array management system can be improved, and the cost can be reduced.

In one aspect of the invention, the battery array management system comprises: a bus; a connection unit coupled between the battery array and the bus; an active balancing unit, a passive balancing unit; a sensing unit; and a control unit.

The active balancing unit is configured to perform constant current charging of each battery unit connected to the bus through a DC-DC converter to perform active balancing of said battery unit; wherein the active balancing unit comprises a primary-side feedback circuit, a secondary-side synchronous rectification circuit, and a transformer coupled between the primary-side feedback circuit and the secondary-side synchronous rectification circuit. The secondary-side synchronous rectification circuit comprises a Schottky diode and a MOS transistor coupled to the Schottky diode, and is directly powered by the plurality of battery units connected to the bus, configured such that, when performing the active balancing of said battery unit, conduction of the MOS transistor is controlled by collecting voltage across the Schottky diode, thereby reducing the conduction voltage; when not performing the active balancing of said battery unit, the secondary-side synchronous rectification circuit enters a sleep state, thereby reducing power consumption and reducing loss of said battery unit.

The passive balancing unit is configured to perform constant current discharging of each battery unit connected to the bus to perform passive balancing of said battery unit.

The sensing unit is configured to sense battery parameters of each battery unit connected to the bus.

The control unit is configured to control the connection unit to connect the plurality of battery units to the bus in turn, and to control the active balancing unit and the passive balancing unit, based on the sensed battery parameters of said battery unit connected to the bus, to perform balancing operations of said battery unit. The control unit operably controls, directly based on the primary-side current of the DC-DC converter, the constant current charging current of said battery unit connected to the bus by the active balancing unit, and performs, based on the secondary-side output of the DC-DC converter, the secondary-side synchronous rectification of the DC-DC converter. In addition, the control unit operably uses the secondary-side current calculated from the primary-side current of the DC-DC converter and the secondary-side voltage sensed by the sensing unit to implement the constant current charging control without the isolated communication circuit between the primary-side and the secondary-side of the DC-DC converter.

In one embodiment, the connection unit comprises a switch array including a plurality of switches, each switch being connected to a corresponding battery unit.

In one embodiment, each switch comprises one of a field effect transistor, an insulated gate bipolar transistor, a thyristor, a triode, a solid-state switch, and a relay.

In one embodiment, the switch array comprises a common-gate and common-source dual-power metal-oxide semiconductors (NMOS) transistor array comprising a plurality of common-gate and common-source dual-power metal-oxide semiconductors (NMOS) transistors.

In one embodiment, through the common-gate and common-source dual power NMOS transistor array, positive and negative terminals of the bus are respectively connected to positive and negative terminals of each battery unit.

In one embodiment, the control unit is connected to a gate of each common-gate and common-source dual-power NMOS transistor to control turn-on and turn-off of each common-gate and common-source dual-power NMOS transistor, so as to connect the corresponding battery unit to the bus.

In one embodiment, the switch array has a driving circuit configured to generate a driving voltage higher than the voltage of the source terminal at a driving terminal of the switch and be controllable.

In one embodiment, the driving circuit is arranged near the battery array, and the control unit realizes selective control of the switch through isolated communication including optical communication.

In one embodiment, the driving circuit is powered by the battery array to generate the driving voltage through a charge pump that boosts the voltage of the battery array to the driving voltage.

In one embodiment, the driving voltage is adapted to enable the switch connected to the battery unit with the highest voltage to conduct, and the driving voltages of other switches are obtainable from the voltage division of the driving voltage generated by the charge pump.

In one embodiment, resistors and/or field effect transistors are used to obtain the voltage division.

In one embodiment, a transformer is used to derive the driving voltage from the battery array.

In one embodiment, the control unit operably controls the connection unit to connect the plurality of battery groups to the bus in turn; the sensing unit operably senses battery parameters of a battery group connected to the bus; and the control unit operably controls the active balancing unit and the passive balancing unit to perform a balancing operation on said battery group based on the battery parameters of said battery group connected to the bus.

In one embodiment, the passive balancing unit comprises a resistor, a transistor and an operational amplifier, and the operational amplifier operably collects voltage across the resistor to control operations of the transistor in a linear area to achieve the constant current discharging.

In one embodiment, the passive balancing unit is configured such that a discharging current flowing through the resistor generates a voltage across the resistor, the operational amplifier collects the voltage and adjusts the transistor based on a reference voltage Vref of the operational amplifier to operate the transistor in a linear region, thereby achieving constant current discharging.

In one embodiment, a discharging current is Vref/R, where R is a resistance value of the resistor.

In one embodiment, the battery parameters comprise at least one of a voltage, a current, an internal resistance, and a temperature of said battery unit.

In one embodiment, the battery parameters further include comprise at least one of a state of charge, a power state, a safety state, and a health state of said battery unit.

In one embodiment, the control unit operably determines, based on the battery parameters sensed by the sensing unit, whether to perform the active balancing and/or the passive balancing of said battery unit connected to the bus through the active balancing unit and/or the passive balancing unit.

In one embodiment, the balancing operation performed by the active balancing unit and the passive balancing unit is based on the parameter P calculated as follows:

$$P = α ( V / V 0 ) + β ( SOC / SOC 0 ) + γ ( SOH / SOH 0 ) + θ ( R / R 0 ) ,$$

wherein V and VO respectively represent a voltage of said battery unit connected to the bus and an average value of voltages of all the battery units; SOC and SOC0 respectively represent a state of charge (SOC) of said battery unit connected to the bus and an average value of SOCs of all the battery units; SOH and SOH0 respectively represent a state of health (SOH) of said battery unit connected to the bus and the average value of SOHs of all the battery units, and R and R0 respectively represent a present internal resistance and an initial internal resistance of said battery unit connected to the bus, and α, β, γ and θ are weights with α+β+γ+θ=1.

In one embodiment, the secondary-side synchronous rectification circuit uses the secondary-side output of the DC-DC converter to directly supply power.

In another aspect of the invention, the battery array management method with the system disclosed above comprising: sequentially connecting the battery units to the bus; sensing battery parameters of the battery units connected to the bus; determining whether the battery units connected to the bus need active balancing and/or passive balancing based on the sensed battery parameters; and performing the active balancing and/or the passive balancing on the battery units connected to the bus according to the determination result.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a block diagram of a management system of a battery array accordingly to one embodiment of the invention.

FIG. 2 is a schematic diagram of a management system of a battery array accordingly to one embodiment of the invention.

FIG. 3 is a circuit diagram of a connection unit accordingly to one embodiment of the invention.

FIG. 4 is a circuit diagram of an active balancing unit accordingly to one embodiment of the invention.

FIG. 5 is a circuit diagram of a secondary-side synchronous rectification circuit integrated in an active balancing unit accordingly to one embodiment of the invention.

FIG. 6 is a circuit diagram of a primary-side feedback circuit integrated in an active balancing unit accordingly to one embodiment of the invention.

FIG. 7 is a circuit diagram of a passive balancing unit accordingly to one embodiment of the invention.

FIG. 8 is a flowchart of a method for managing a battery array accordingly to one embodiment of the invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this specification will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures, is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

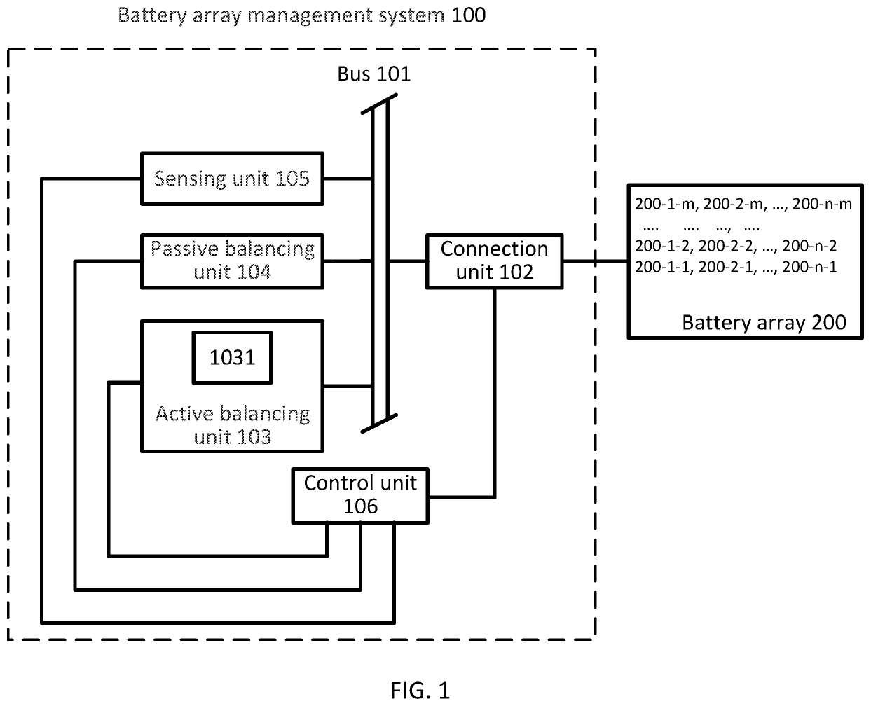

The description will be made as to the embodiments of the invention in conjunction with the accompanying drawings in FIGS. 1-8. In accordance with the purposes of this invention, as embodied and broadly described herein, this invention, in certain aspects, relates to a system and a method for managing a battery array.

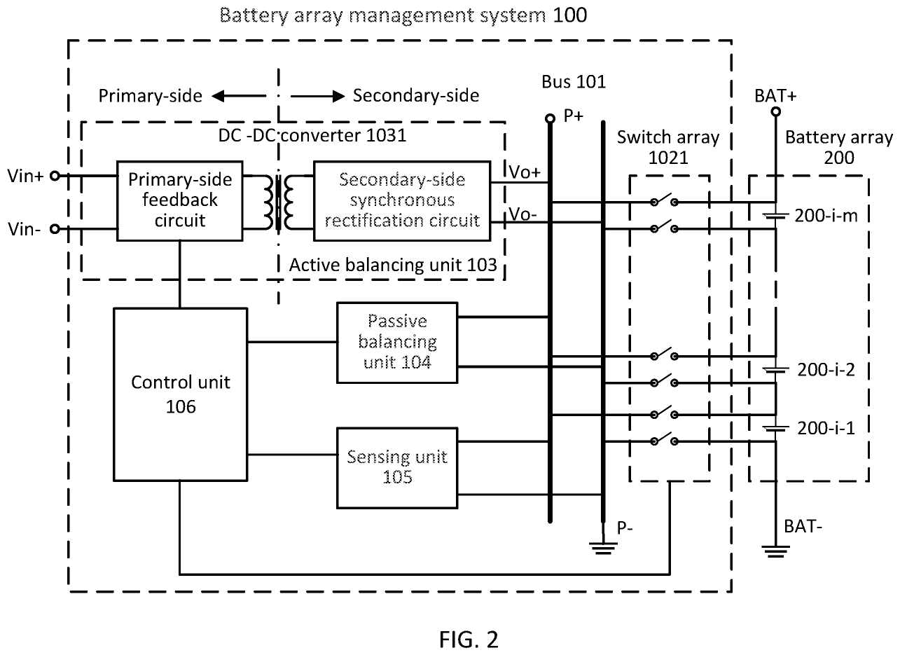

Referring to FIGS. 1-2, the system 100 for managing a battery array (or alternatively, battery array management system 100) is schematically shown according to some embodiments of the invention. In some examples, the battery array 200 includes a plurality of battery groups {200-i} connected in parallel, each battery group 200-j includes a plurality of battery units {200-i-j} connected in series, i=1, 2, 3, . . . n, and m=1, 2, 3, . . . m. It should be noted that the battery groups and battery units in the battery array can be connected to each other in other configurations. In addition, the term “battery unit”, used herein, is exchangeable with “battery cell”, “cell”, “single battery”, or “battery”. As shown in FIGS. 1-2, the battery array management system 100 includes a bus 101 having a positive terminal P+ and ta negative terminal P−, a connection unit 102 coupled between the bus 101 and the battery array 200, an active balancing unit 103 configured to, through charging a battery unit 200-i-j connected to the bus 101 with a constant current by a DC-DC converter 1031, perform active balancing of the battery unit 200-i-j, a passive balancing unit 104 configured to, through discharging the battery unit 200-i-j connected to the bus 101 with a constant current, perform passive balancing of the battery unit 200-i-j, a sensing unit 105 configured to configured to sense battery parameters of the battery unit 200-i-j connected to the bus 101, and a control unit 106 configured to control the connection unit 102 to sequentially connect the plurality of battery units {200-i-j} to the bus 101, and to control the active balancing unit 103 and the passive balancing unit 104, based on the sensed battery parameters of the battery unit 200-i-j connected to the bus, to perform balancing operations of the battery unit 200-i-j.

In some embodiments, the control unit 106 operably controls the active balancing unit 103, based on the primary-side current of the DC-DC converter 1031, to charge the battery unit 200-i-j connected to the bus 101 with the constant current, and to perform secondary-side synchronous rectification of the DC-DC converter 1031 based on the secondary-side output of the DC-DC converter 1031.

In one embodiment, the input terminals Vin+ and Vin− of the DC-DC converter 1031 may be connected to the output of a battery, an auxiliary battery or an AC-DC switching power supply. The output ports Vo+ and Vo− of the DC-DC converter 1031 can be respectively connected to the positive terminal P+ and the negative terminal P− of the bus 101, and then connected to the positive terminal BAT+ and the negative terminal BAT− of the corresponding battery unit via the connection unit 102, as shown in FIGS. 1-2.

As shown in FIGS. 1-2, in one embodiment, the battery array 200 may include a plurality of battery groups 200-1, 200-2, . . . , 200-n (n is a natural number greater than 1) connected in parallel, each battery group 200-i (1≤i≤n) includes a plurality of battery units 200-i-1, 200-i-2, . . . , 200-i-m (m is a natural number greater than 1) connected in series. Accordingly, a plurality of battery units 200-i-j (1≤j≤m) can form an m×n battery array 200.

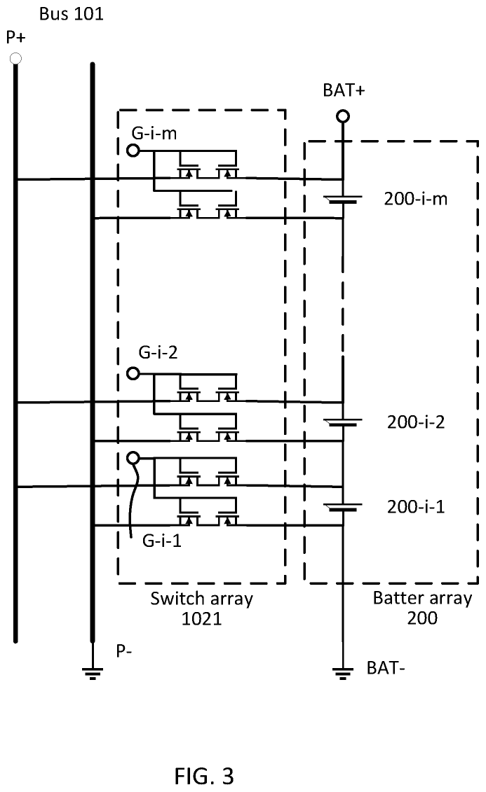

As described below in conjunction with FIG. 3, in one embodiment, the connection unit 102 may be a switch array 1021 including a plurality of switches, each of which is connected to a corresponding battery unit 200-i-j.

In one embodiment, the control unit 106 can control each switch in the switch array 1021 to be turned on and off, so as to connect each battery unit 200-i-j to the bus 101 in turn. In addition, as shown in FIGS. 1-2, each of the active balancing unit 103, the passive balancing unit 104, and the sensing unit 105 is connected to the bus 101, and then connected to each battery unit 200-i-j in turn via the connecting unit 102 composed of, for example, a switch array 1021. Each battery unit 200-i-j. In one embodiment, the control unit 106 controls the connection unit 102 such that at any moment, only one battery unit is connected to the bus 101.

Referring to FIG. 3, the connection unit 102 is shown according to one embodiment of the invention. In the exemplary embodiment, the connection unit 101 may be realized as an array 1021 of electronic switches for connecting each battery group 200-i to the bus 101. In order to ensure the turn-on times and bidirectional controllability of the electronic switch array 1021, and meanwhile require a certain efficiency flow capacity, each switch of the electronic switch array can be one of a field effect transistor, an insulated gate bipolar transistor, a thyristor, a triode, a solid-state switch and a relay. Alternatively, the switch can also be another element with the same switching functions.

As a specific example, as shown in FIG. 3, the electronic switch array 1021 can be realized by using a common-gate and common-source dual-power NMOS transistor array. The positive terminal P+ of the bus 101 is connected, through the common-gate and common-source dual power NMOS transistors, to the positive terminal BAT+ of each battery unit 200-i-j in the battery group 200-i. The negative terminal P− of the bus 101 is connected, through the common-gate and common-source dual power NMOS transistors, to the negative electrode BAT− of each battery unit 200-i-j in the battery group 200-i. The control unit 106 is connected to the gate G-i-j of each common-gate and common-source dual-power NMOS transistor to control the turn-on and turn-off of each common-gate and common-source dual-power NMOS transistor, so that the corresponding battery unit 200-i-j is connected to the bus 101.

In some embodiments, the driving circuit of the electronic switch array needs to generate a driving voltage higher than the voltage of the source terminal at the driving terminal of the electronic switch and be controllable. The driving circuit can be arranged near the battery array, and the control unit 106 can realize selective control of the switch through, for example, isolated communication (such as optical communication). The driving circuit can be powered by the battery array to generate the required driving voltage through, for example, a charge pump. In one example, through the charge pump to boost the voltage of the battery array (i.e., the voltage of the battery group) to the required driving voltage. This driving voltage must enable the switch connected to the battery unit with the highest voltage to be turned on. The driving voltages of other switches can be obtained from the voltage division of the driving voltage generated by the charge pump. In some embodiments, resistors or field effect transistors can be used to obtain the voltage division. Alternatively, a transformer can be used to derive the required driving voltage from the battery array.

The active balancing unit 103 and the passive balancing unit 104 are used to perform balancing operations on the battery unit 200-i-j connected to the bus 101. The significance of balancing is to use electronic technology to keep the deviation of each battery unit within the expected range, so as to ensure that each battery unit will not be damaged during normal use. If no balancing control is performed, the voltage of each battery unit will gradually differentiate with the increase of charging and discharging cycles, thereby resulting in a greatly reduced service life of the battery array. Active balancing is performed by means of charge transfer between the battery units, which has the advantages of high efficiency and low loss, while passive balancing generally discharges the battery unit with higher voltage through load discharging, which has the advantages of low cost and simplicity of circuit designs. By using the active balancing and passive balancing, different balancing strategies can be applied to different scenarios, thereby efficiently implementing consistent management of the battery array.

In some embodiments, under the control of the control unit 106, the active balancing unit 103 charges the battery unit 200-i-j connected to the bus 101 with a constant current through the DC-DC converter 1031 to perform active balancing of the battery unit 200-i-j.

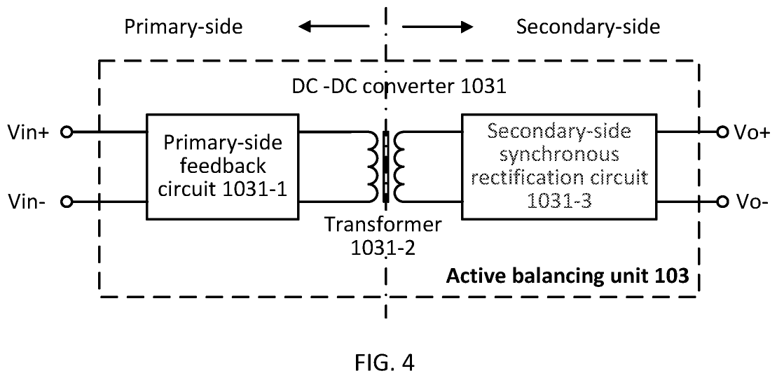

FIG. 4 is a circuit diagram illustrating the active balancing unit 103 according to one embodiment of the invention. In this example, the active balancing unit 103 include a DC-DC converter 1031 that is composed of a primary-side feedback circuit 1031-1, a transformer 1031-2 and a secondary-side synchronous rectification circuit 1031-3 coupled to each other.

In some embodiments, the input terminals Vin+ and Vin− of the DC-DC converter 1031 may be connected to the output of a battery, an auxiliary battery, or an alternating current-direct current (AC-DC) switching power supply. The output terminals Vo+ and Vo− of the DC-DC converter 1031 can be respectively connected to the positive terminal P+ and the negative terminal P− of the bus 101, and then connected to the corresponding battery units via the connection unit 102.

In some embodiments, the control unit 106 operably controls, directly based on the primary-side current of the DC-DC converter 1031, the constant current charging current of the battery unit 200-i-j connected to the bus 101 by the active balancing unit 103, and performs, based on the secondary-side output of the DC-DC converter 1031, the secondary-side synchronous rectification of the DC-DC converter 1031.

Conventionally, the secondary-side circuit of the DC-DC converter has two schemes of synchronous rectification and non-synchronous rectification. In the non-synchronous rectification scheme, in order to reduce energy loss, the secondary-side circuit usually uses a Schottky diode with a lower conduction voltage as the rectifier diode. However, considering that the voltage of the battery units is usually 3.2V or even lower, even though the conduction voltage of the Schottky diode is reduced (typically 0.5V), when charging each battery group to perform the active balancing, there is still a large efficiency loss (0.5V/3.2V) in the conduction voltage drop, and a large amount of heat is generated.

In order to improve efficiency, a synchronous rectification scheme has been proposed, in which MOS transistors are used to replace the Schottky diode. Generally, the synchronous rectification scheme uses a pulse width modulation (PWM) controller on the primary-side circuit to generate a PWM signal for the MOS transistor of the primary-side circuit and a PWM signal for the MOS transistor of the secondary-side circuit and controls the timing and dead time of the two PWM signals so as to control the MOS transistors of the primary-side circuit and the MOS transistors of the secondary-side circuit. This kind of the PWM controllers usually realizes the driving of the MOS transistor of the secondary-side circuit by the PWM controller of the primary-side circuit through an isolation driving transformer or an isolation driving dedicated circuit. However, this driving method is costly and has a large isolation driving area, making it difficult to integrate into the chip, which is not conducive to integrated design.

In some embodiments, the control unit 106 performs synchronous rectification of the secondary-side of the DC-DC converter 1031 directly based on the output of the secondary-side of the DC-DC converter 1031 without the control signal of the primary-side of the DC-DC converter 1031.

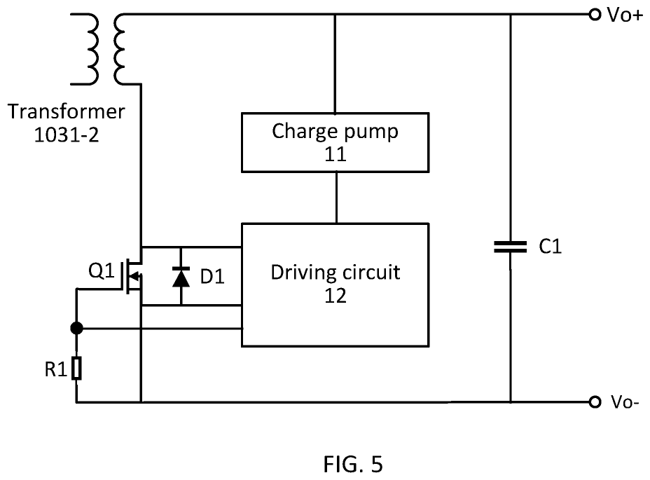

Referring to FIG. 5, a circuit diagram illustrating a secondary-side synchronous rectification circuit 1031-3 integrated in the active balancing unit 103 (FIG. 4) is shown according to one embodiment of the invention. In this exemplary embodiment, the secondary-side synchronous rectification circuit 1031-3 includes a MOS transistor Q1 having source and drain terminals electrically coupled between the output terminal Vo− of the active balancing unit 103 and a terminal of the secondary-side winding of the transformer 1031-2; and a Schottky diode D1 having two terminals respectively connected to the source and drain terminals of the MOS transistor Q1. The conduction of the MOS transistor Q1 is controlled by collecting the voltage across the Schottky diode D1. After the MOS transistor is turned on, the voltage drops across it is reduced from the turn-on voltage of the Schottky diode D1 of about 0.5V to the turn-on voltage of the MOS transistor Q1 of about 20 mV, which can greatly improve the efficiency of the management system 100. In addition, the secondary-side synchronous rectification circuit is directly powered by the secondary-side output, and its operating voltage is only 1.5V to 5V, which can meet the needs of most application scenarios.

As shown in FIG. 5, the secondary-side synchronous rectification circuit 1031-3 further includes a resistor R1 electrically coupled between the gate terminal of the MOS transistor Q1 and the output terminal Vo− of the active balancing unit 103; a driving circuit 12 electrically coupled to the gate terminal of the MOS transistor Q1 and the two terminals of the Schottky diode D1; a charge pump 11 electrically coupled between the driving circuit 12 and the output terminal Vo+ of the active balancing unit 103; and a capacitor C1 electrically coupled between the output terminals Vo+ and Vo− of the active balancing unit 103.

In one embodiment, when the battery unit is connected to the bus 101, the output terminals Vo+ and Vo− of the active balancing unit 103 are directly connected to the two ends of the battery unit to establish the battery voltage. As discussed above, the battery voltage can be boosted to a higher voltage through the charge pump 11 for power supply and driving of the driving circuit 12. The driving circuit 12 controls the MOS transistor Q1 to be turned on according to the voltage across the Schottky diode D1 (i.e., the source voltage and the drain voltage of the MOS transistor Q1), which can reduce the overall power consumption of the management system 100. In addition, when the management system 100 does not perform active balancing, the secondary-side synchronous rectification circuit 1031-3 enters a sleep/dormant state, which is an extremely low static power consumption state, so as to avoid damage to the battery units.

Further, in one embodiment, the control unit 106 can control the constant charging current of the active balancing unit 103 to the battery units connected to the bus 101 based on the primary-side current of the DC-DC converter 1031.

Since the active balancing unit 103 does not need to consider load changes when charging the battery units to perform active balancing, in one embodiment, the constant current charging of the active balancing unit 103 can be realized by means of primary-side current feedback, therefor the primary-side feedback circuit 1031-1 (FIG. 4) can be integrated with other components of the management system 100 to increase the degree of integration, thereby realizing a design with high reliability, low cost and small size. In addition, the DC-DC converter 1031 of the active balancing unit 103 does not require an isolated communication circuit between the primary-side and the secondary-side and does not need to use a complex transformer with auxiliary windings, which further simplifies the circuit structure of the management system 100.

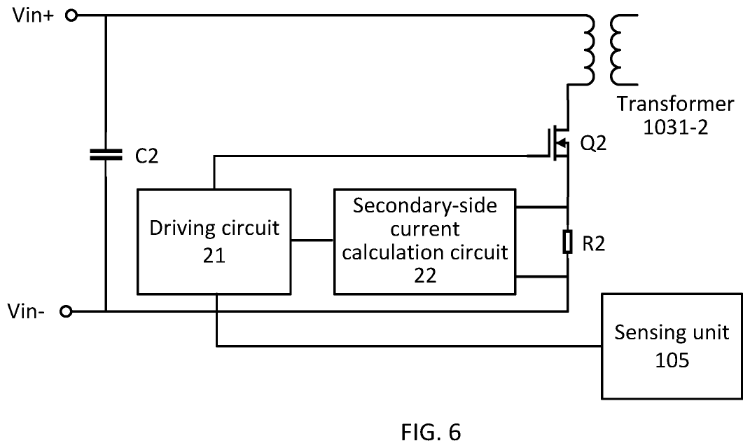

FIG. 6 shows a circuit diagram illustrating a primary-side feedback circuit 1031-1 integrated in the active balancing unit 103 according to one embodiment of the invention. In this example, the primary-side feedback circuit 1031-1 includes a resistor R2 having one terminal electrically connected to the input terminal Vin− of the active balancing unit 103; a MOS transistor Q2 having a source terminal electrically connected to another terminal of the resistor R1 and a drain terminal electrically connected to a terminal of the primary-side winding of the transformer 1031-2, a secondary-side current calculation circuit 22 electrically connected between the two terminals of the resistor R2; a driving circuit 21 electrically connected to the gate terminal of the MOS transistor Q2, the secondary-side current calculation circuit 22 and the sensing unit 105; and a capacitor C2 electrically connected between the input terminals Vin+ and Vin− of the active balancing unit 103.

The primary-side feedback circuit 1031-1 uses the resistor R2 to collect the primary-side current of the DC-DC converter 1031 to calculate the stable current of the secondary-side of the DC-DC converter 1031 by a secondary-side current calculation circuit 22. In the primary-side feedback circuit, it is not necessary to obtain the feedback of the output voltage of the secondary-side through a voltage acquisition circuit such as an auxiliary winding or other means, and the voltage of the battery unit (i.e., the output voltage of the secondary-side of the DC-DC converter 1031) sensed by the sensing unit 105 can be used to get the feedback of the output voltage directly. In this way, the driving circuit 21 can use the combination of the current and voltage of the secondary-side of the DC-DC converter 1031 obtained as described above to realize accurate constant current charging control.

In one embodiment, the primary-side feedback circuit can also be formed indirectly through the monitoring of the voltage of the battery unit by the sensing unit 105. For example, when the active balancing unit 103 performs the active balancing on the battery unit connected to the bus 101, if the sensing unit 105 detects that the voltage of the battery unit exceeds a preset threshold, the control unit 105 can control the driving circuit in the primary-side feedback circuit to cut off the power output or reduce the power output.

In one embodiment, since the passive balancing unit 104 is shared among multiple battery units through the bus 101 and the connection unit 102, a larger passive balancing current can be obtained, resulting in lower cost.

Conventionally, the passive balancing circuit is usually composed of a MOS transistor and a resistor, wherein the MOS transistor only works in the on state or off state and performs passive balancing through the discharge of the resistor in the on state. In the working state, the MOS transistor is only used as a switch, so the passive balancing current is determined according to the voltage of the battery unit and the resistance value of the resistor, resulting in a non-constant discharge current, thereby making it difficult to estimate the discharge capacity.

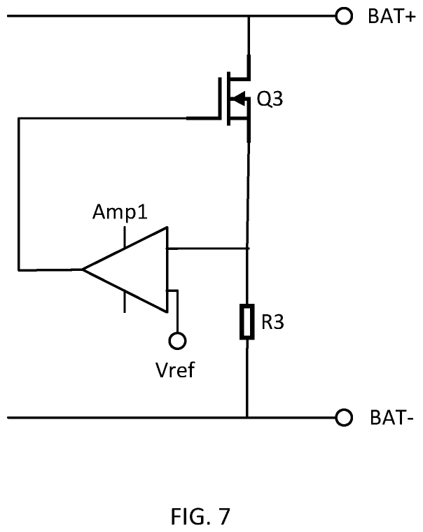

In one embodiment, as shown in FIG. 7, the passive balancing unit 104 may include a resistor R3 having one terminal electrically connected to the negative terminal BAT− of a corresponding battery unit, a MOS transistor Q3 having a source terminal electrically connected to another terminal of the resistor R3 and a drain terminal electrically connected to the positive terminal BAT+ of the corresponding battery unit, and an operational amplifier Amp1 having one of the dual supply terminals electrically connected to the source terminal of the MOS transistor Q3, another one of the dual supply terminals electrically connected to a reference voltage (Vref), and the output terminal electrically connected to the gate terminal of the MOS transistor Q3. As such an arrangement, in operation, the voltage of the resistor R3 is collected by the operational amplifier Amp1 to control the MOS transistor Q3 to work in a linear region to achieve the constant current discharging. In one embodiment, the discharge current flowing through the resistor R3 generates a voltage across the resistor R3. The operational amplifier Amp1 collects the voltage and adjusts the MOS transistor Q3 to work in the linear region based on the reference voltage Vref, thereby realizing the constant current discharging. Specifically, the discharge current is Vref/R, where R is the resistance value of the resistor R3.

In one embodiment, the battery parameter sensed by the sensing unit 105 may include at least one of a voltage, a current, an internal resistance and a temperature of the battery unit. In addition, the battery parameters may also include the battery unit's state of charge (SOC, such as the percentage of remaining battery power), state of power (SOP, such as the input/output power range of the battery array, including charging and discharge safety limit value), state of safe (SOS, such as the probability of no failure, e.g., thermal runaway, under the condition of ensuring the normal charging and discharging function of the battery array) and/or state of health (SOH, such as the percentages of the current capacity of the battery to the factory capacity of the battery).

In one embodiment, the control unit 106 may determine according to the battery parameters sensed by the sensing unit 105 whether to perform active balancing and/or passive balancing on the battery unit connected to the bus 101 through the active balancing unit 103 and/or the passive balancing unit 104.

In the embodiment, the functions of the battery parameter collection, passive balancing and active balancing of the management system 100 can be implemented by polling in a time-division multiplexed manner, so logic control needs to be performed according to time sequence.

In one embodiment, the control unit 106 can control the connection unit 102 to connect the battery units to the bus 101 in sequence, so that the sensing unit 105 can sense the voltage sequence of all the battery units in a polling manner, and obtain, for example, the battery parameters such as SOC, SOH and internal resistance. The sensing operation can be continuously repeated to obtain real-time information of each battery unit.

In one embodiment, the control unit 106 may perform a balancing operation according to a balancing strategy based on battery parameters. The balancing strategy is used to determine whether to perform the balancing operation, for which battery group to perform the balancing operation, and whether to perform the active balancing operation or the passive balancing operation. The balancing strategy is described in more detail below.

In one embodiment, if the control unit 106 determines that the balancing operation needs to be performed, a period of time T for performing the balancing operation is set, during which the sensing unit 105 is controlled to stop sensing battery parameters in a polling manner, and a balancing operation is performed on the battery unit that needs to be balanced. During the balancing operation, the sensing unit 105 may continuously sense the battery parameters of the battery unit that needs to be balanced. For example, in the period of time T for the balancing operation, let to be the start time point of the period of time T, at this time the sensing unit 105 senses the battery parameters of the battery unit that needs to be balanced, such as obtaining the voltage Vt0 of the battery unit. In addition, let t1 be the time point when the balance current is stable, at this time, the voltage Vt1 of the battery unit is obtained, and the voltage variation ΔVt=Vt1−Vt0 is calculated. In addition, assuming that the voltage sensed by the sensing unit 105 during the balancing operation period is Vs, the actual voltage Vr of the battery unit is approximately Vs−ΔVt. In one embodiment, the control unit 106 can monitor whether the voltage Vr is within a normal preset range during the balancing operation. If the voltage Vr is not within the preset range, the balancing operation is stopped, the polling state is entered, and fault diagnosis and protection actions are performed.

In one embodiment, when the period of time T elapses, the control unit 106 stops the balancing operation, and controls the sensing unit 105 to continuously sense the battery parameters of other battery units in a polling manner. The management system 100 implements consistent management of all battery units in the battery array by repeating the above steps.

The purpose of the balancing operation performed by the management system 100 is to make the battery array 200 have the maximum available capacity. In one embodiment, the balancing strategy is set based on the calculation of the following parameters:

$$P = α ( V / V 0 ) + β ( SOC / SOC 0 ) + γ ( SOH / SOH 0 ) + θ ( R / R 0 ) ,$$

where V and VO respectively represent a voltage of said battery unit connected to the bus and an average value of voltages of all the battery units; SOC and SOC0 respectively represent a state of charge (SOC) of said battery unit connected to the bus and an average value of SOCs of all the battery units; SOH and SOH0 respectively represent a state of health (SOH) of said battery unit connected to the bus and the average value of SOHs of all the battery units, and R and R0 respectively represent a present internal resistance and an initial internal resistance of said battery unit connected to the bus, and α, β, γ and θ are weights with α+β+γ+θ=1. The parameter P can be expressed as a percentage.

In one embodiment, the balancing strategy may be based on a number of rules regarding the parameter P. For example, the balancing operation is always performed on the battery unit with the smallest value of the parameter P. In addition, when the difference between the maximum value and the minimum value of the parameter P exceeds a preset threshold, the control unit 106 controls the active balancing unit 103 to perform active balancing on the battery unit with the minimum value of the parameter P, and controls the passive balancing unit 104 to perform the passive balancing on the battery unit with the maximum value of parameter P. Other rules can be envisioned by those skilled in the art in light of the teachings of this disclosure.

In one embodiment, when performing a balancing operation according to a balancing strategy, the control unit 106 may control the connecting unit 102 to connect the bus 101 to a battery unit that needs to be balanced, control the sensing unit 105 to sense the battery parameters of the battery unit, and the balancing operation is performed on the battery unit within a preset time period (e.g., the period of the T disclosed above).

In one embodiment, the weights α, β, γ and θ may be set according to specific application scenarios. For example, the weights α, β, γ, and θ may have different values according to the operating state of the management system 100 and the operating state of the battery array 200. In some examples, during the active balancing, the values of the weights β and γ may be increased to ensure that the active balancing is performed on the battery unit with the least amount of charge, thereby increasing the dischargeable capacity of the battery array. In some examples, in the case that the battery unit is a lithium iron phosphate battery, when the state of charge is in the range of 30% to 70%, increasing the values of the weights β and γ can improve the effectiveness of the balancing.

Although the embodiments of the invention are described above with respect to the operation of each battery unit in connection with the management system 100, the invention is not limited thereto. In some embodiments, the management system 100 may also perform various operations on a battery group including a plurality of battery units, including sensing battery parameters and performing balancing operations of the battery group.

In some embodiments, the control unit 106 may control the connection unit 102 to sequentially connect a plurality of battery groups 200-i to the bus 101, control the sensing unit 205 to sense battery parameters of the battery groups 200-i connected to the bus 101. And based on the battery parameters of the battery group 200-i connected to the bus 101, the active balancing unit 103 and the passive balancing unit 104 are controlled to perform a balancing operation on the battery group 200-i.

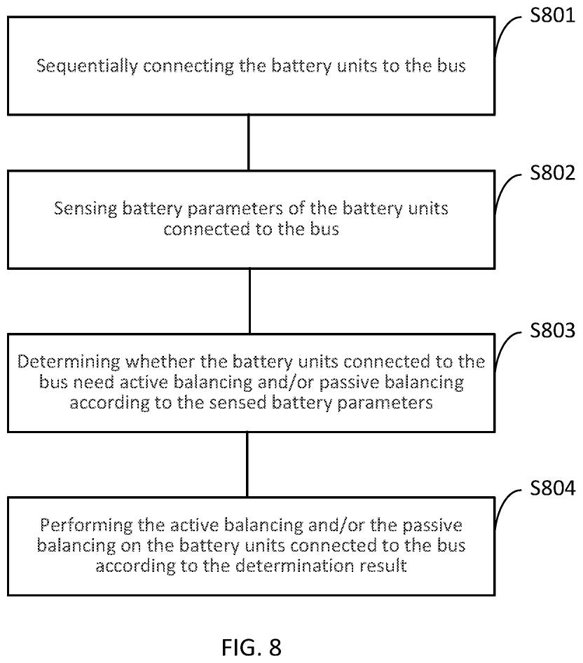

One aspect of the invention also provides a method for managing a battery array using the battery array management system 100 as described above. FIG. 8 shows a flowchart illustrating the method 800 for managing the battery array according to one embodiment of the invention. In the exemplary embodiment, the method 800 may include the following steps:
Step S801: sequentially connecting the battery units to the bus;
Step S802: sensing battery parameters of the battery units connected to the bus;
Step S803: determining whether the battery units connected to the bus need active balancing and/or passive balancing according to the sensed battery parameters; and
Step S804: performing the active balancing and/or the passive balancing on the battery units connected to the bus according to the determination result.

In one embodiment, step S802 to step S804 may be repeatedly executed for each battery unit sequentially connected to the bus to achieve consistent management of the battery array.

In sum, according to embodiments of the battery array management system, the parameter sensing, the active balancing and/or the passive balancing of each battery unit can be realized in a time-division multiplexing manner by using a switch array, thereby simplifying the hardware structure of the system. In addition, the hardware structure of the battery array management system can be further simplified by optimizing the DC-DC converter used for charging the battery units. By simplifying the hardware structure of the battery array management system, the integration degree of the battery array management system can be improved and the cost can be reduced.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

What is claimed is:

1. A system for managing a battery array, wherein the battery array includes a plurality of battery groups connected in parallel, each battery group includes a plurality of battery units connected in series, the system comprising:
a bus;
a connection unit coupled between the battery array and the bus;
an active balancing unit configured to perform constant current charging of each battery unit connected to the bus through a DC-DC converter to perform active balancing of said battery unit; wherein the active balancing unit comprises a primary-side feedback circuit, a secondary-side synchronous rectification circuit, and a transformer coupled between the primary-side feedback circuit and the secondary-side synchronous rectification circuit; wherein the secondary-side synchronous rectification circuit comprises a Schottky diode and a MOS transistor coupled to the Schottky diode, and is directly powered by the plurality of battery units connected to the bus, configured such that, when performing the active balancing of said battery unit, conduction of the MOS transistor is controlled by collecting voltage across the Schottky diode, thereby reducing the conduction voltage; when not performing the active balancing of said battery unit, the secondary-side synchronous rectification circuit enters a sleep state, thereby reducing power consumption and reducing loss of said battery unit;
a passive balancing unit configured to perform constant current discharging of each battery unit connected to the bus to perform passive balancing of said battery unit;
a sensing unit configured to sense battery parameters of each battery unit connected to the bus; and
a control unit configured to control the connection unit to connect the plurality of battery units to the bus in turn, and to control the active balancing unit and the passive balancing unit, based on the sensed battery parameters of said battery unit connected to the bus, to perform balancing operations of said battery unit,
wherein the control unit operably controls, directly based on the primary-side current of the DC-DC converter, the constant current charging current of said battery unit connected to the bus by the active balancing unit, and performs, based on the secondary-side output of the DC-DC converter, the secondary-side synchronous rectification of the DC-DC converter; and
wherein the control unit operably uses the secondary-side current calculated from the primary-side current of the DC-DC converter and the secondary-side voltage sensed by the sensing unit to implement the constant current charging control without the isolated communication circuit between the primary-side and the secondary-side of the DC-DC converter.

2. The system of claim 1, wherein the connection unit comprises a switch array including a plurality of switches, each switch being connected to a corresponding battery unit.

3. The system of claim 2, wherein each switch comprises one of a field effect transistor, an insulated gate bipolar transistor, a thyristor, a triode, a solid-state switch, and a relay.

4. The system of claim 2, wherein the switch array comprises a common-gate and common-source dual-power metal-oxide semiconductors (NMOS) transistor array comprising a plurality of common-gate and common-source dual-power metal-oxide semiconductors (NMOS) transistors,
wherein, through the common-gate and common-source dual power NMOS transistor array, positive and negative terminals of the bus are respectively connected to positive and negative terminals of each battery unit; and
wherein the control unit is connected to a gate of each common-gate and common-source dual-power NMOS transistor to control turn-on and turn-off of each common-gate and common-source dual-power NMOS transistor, so as to connect the corresponding battery unit to the bus.

5. The system of claim 4, wherein the switch array has a driving circuit configured to generate a driving voltage higher than the voltage of the source terminal at a driving terminal of the switch and be controllable.

6. The system of claim 5, wherein the driving circuit is arranged near the battery array, and the control unit realizes selective control of the switch through isolated communication including optical communication.

7. The system of claim 5, wherein the driving circuit is powered by the battery array to generate the driving voltage through a charge pump that boosts the voltage of the battery array to the driving voltage.

8. The system of claim 7, wherein the driving voltage is adapted to enable the switch connected to the battery unit with the highest voltage to conduct, and the driving voltages of other switches are obtainable from the voltage division of the driving voltage generated by the charge pump.

9. The system of claim 8, wherein resistors and/or field effect transistors are used to obtain the voltage division.

10. The system of claim 8, wherein a transformer is used to derive the driving voltage from the battery array.

11. The system of claim 1,
wherein the control unit operably controls the connection unit to connect the plurality of battery groups to the bus in turn;
wherein the sensing unit operably senses battery parameters of a battery group connected to the bus; and
wherein the control unit operably controls the active balancing unit and the passive balancing unit to perform a balancing operation on said battery group based on the battery parameters of said battery group connected to the bus.

12. The system of claim 1, wherein the passive balancing unit comprises a resistor, a transistor and an operational amplifier, and the operational amplifier operably collects voltage across the resistor to control operations of the transistor in a linear area to achieve the constant current discharging.

13. The system of claim 12, wherein the passive balancing unit is configured such that a discharging current flowing through the resistor generates a voltage across the resistor, the operational amplifier collects the voltage and adjusts the transistor based on a reference voltage Vref of the operational amplifier to operate the transistor in a linear region, thereby achieving constant current discharging.

14. The system of claim 13, wherein a discharging current is Vref/R, where R is a resistance value of the resistor.

15. The system of claim 1, wherein the battery parameters comprise at least one of a voltage, a current, an internal resistance, and a temperature of said battery unit.

16. The system of claim 15, wherein the battery parameters further include comprise at least one of a state of charge, a power state, a safety state, and a health state of said battery unit.

17. The system of claim 1, wherein the control unit operably determines, based on the battery parameters sensed by the sensing unit, whether to perform the active balancing and/or the passive balancing of said battery unit connected to the bus through the active balancing unit and/or the passive balancing unit.

18. The system of claim 1, wherein the balancing operation performed by the active balancing unit and the passive balancing unit is based on the parameter P calculated as follows:
$$P = α ( V / V 0 ) + β ( SOC / SOC 0 ) + γ ( SOH / SOH 0 ) + θ ( R / R 0 ) ,$$
wherein V and VO respectively represent a voltage of said battery unit connected to the bus and an average value of voltages of all the battery units; SOC and SOC0 respectively represent a state of charge (SOC) of said battery unit connected to the bus and an average value of SOCs of all the battery units; SOH and SOH0 respectively represent a state of health (SOH) of said battery unit connected to the bus and the average value of SOHs of all the battery units, and R and R0 respectively represent a present internal resistance and an initial internal resistance of said battery unit connected to the bus, and α, β, γ and θ are weights with α+β+γ+θ=1.

19. The system of claim 1, the secondary-side synchronous rectification circuit uses the secondary-side output of the DC-DC converter to directly supply power.

20. A method for managing a battery array using the system according to claim 1, comprising:
sequentially connecting the battery units to the bus;
sensing battery parameters of the battery units connected to the bus;
determining whether the battery units connected to the bus need active balancing and/or passive balancing based on the sensed battery parameters; and
performing the active balancing and/or the passive balancing on the battery units connected to the bus according to the determination result.
